(19) United States
(12) Patent Application Publication
(10) Pub. No.: US 2013/0175345 A1
(43) Pub. Date: Jul. 11, 2013

(54) INDICIA READING TERMINAL HAVING DYNAMIC DECODABLE INDICIA REPRESENTATION SEARCH

(71) Applicant: Colleen P. Gannon, Marcellus, NY (US)

(72) Inventor: Colleen P. Gannon, Marcellus, NY (US)

(73) Assignee: Honeywell International Inc. doing business as (d.b.a) Honeywell Scanning and Mobility, Fort Mill, SC (US)

(21) Appl. No.: 13/343,979

(22) Filed: Jan. 5, 2012

(51) Int. Cl. G06K 7/14

(52) U.S. Cl. 235/470

(57) ABSTRACT

There is set forth herein in one embodiment an indicia reading terminal having an imaging assembly operative so that a manner in which a decodable indicia representation is searched for is responsive to one or more of a terminal to target distance and a projected light pattern representation.

### FIELD OF THE INVENTION

The present invention relates in general to optical based registers, and particularly is related to an image sensor based indicia reading terminal.

### BACKGROUND OF THE INVENTION

Indicia reading terminals for reading decodable indicia are available in multiple varieties. For example, minimally featured indicia reading terminals devoid of a keyboard and display are common in point of sale applications. Indicia reading terminals devoid of a keyboard and display are available in the recognizable gun style form factor having a handle and trigger button (trigger) that can be actuated by an index finger. Indicia reading terminals having keyboards and displays are also available. Keyboards and display equipped indicia reading terminals are commonly used in shipping and warehouse applications, and are available in form factors incorporating a display and keyboard. In a keyboard and display equipped indicia reading terminal, a trigger button for actuating the output of decoded messages is typically provided in such locations as to enable actuation by a thumb of an operator. Indicia reading terminals in a form devoid of a keyboard and display or in a keyboard and display equipped form are commonly used in a variety of data collection applications including point of sale applications, shipping applications, warehousing applications, security check point applications, and patient care applications.

Some indicia reading terminals are adapted to read bar code symbols including one or more of one dimensional (1D) bar codes, stacked 1D bar codes, and two dimensional (2D) bar codes. Other indicia reading terminals are adapted to read OCR characters while still other indicia reading terminals are equipped to read both bar code symbols and OCR characters.

### SUMMARY OF THE INVENTION

There is set forth herein in one embodiment an indicia reading terminal having an imaging assembly operative so that a manner in which a decodable indicia representation is searched for is responsive to one or more of a terminal to target distance and a projected light pattern representation.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 is a representation of a frame of image data at close ready range;

FIG. 2 is a representation of a frame of image data at far ready range;

FIG. 3 is a representation of a target substrate at close range onto which an aiming pattern is projected;

FIG. 4 is a representation of a target substrate at far ready range onto which an aiming pattern is projected;

FIG. 5 is a block diagram of an indicia reading terminal;

FIG. 6 is a perspective view of an indicia reading terminal having a plurality of operator selectable configurations;

FIG. 7 is a representation of a lookup table;

FIG. 8 is a timing diagram illustrating the relationship between the aimer, exposure, readout signal and processing.

### DETAILED DESCRIPTION OF THE INVENTION

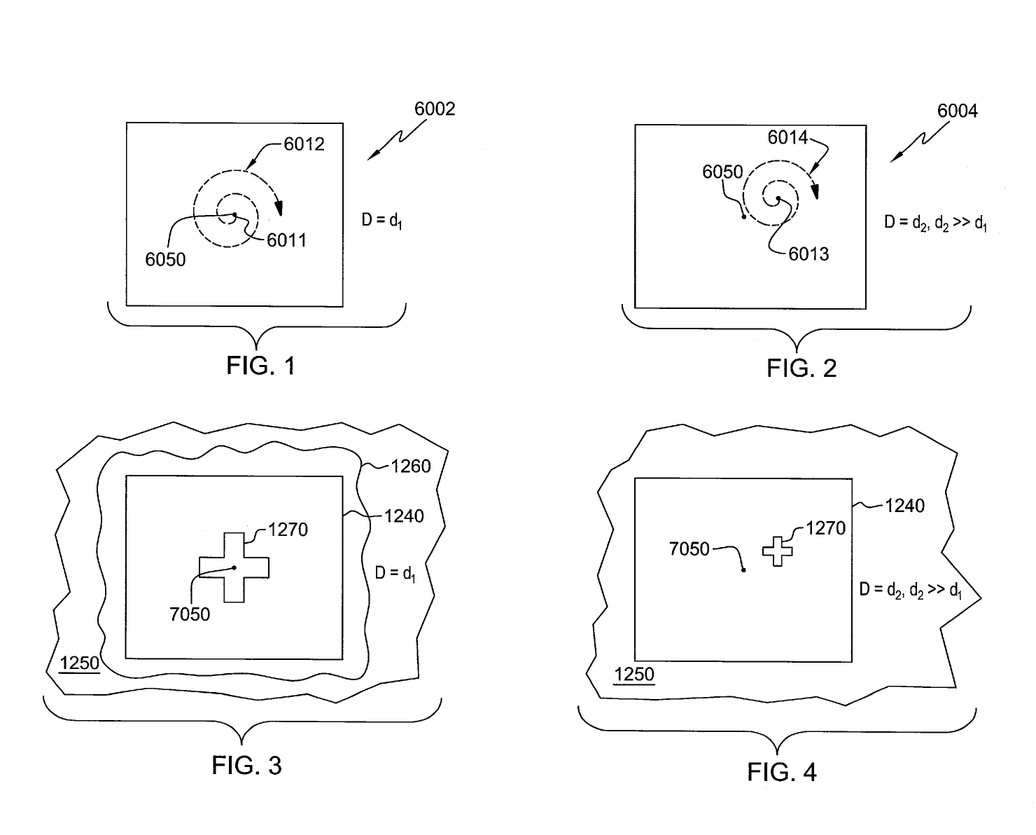

There is set forth herein in one embodiment an indicia reading terminal in which a manner in which a decodable indicia is searched for can be responsive to a terminal to target distance. For example, referring to FIG. 1, FIG. 1 is a representation of a frame of image data 6002 captured with a terminal being at a first close range distance to a target substrate. When frame 6002 captured at close range is subject to decoding, a search pattern can be utilized. A search pattern for searching for decodable indicia, such as a bar code symbol representation, can be as depicted by search pattern 6012; namely a search pattern that commences at the center (x=xₒ, y=yₒ) pixel position 6050 of frame of image data 6002. Search pattern 6012 can include a search pattern commencement position 6011 that is coincident with a center pixel position 6050 of frame 6002.

However, in accordance with an indicia reading terminal set forth herein, at long range (FIG. 2), a manner of searching for decodable indicia can be different. FIG. 2 is a representation of a frame of image data 6004 captured with a terminal being at far range distance to a target substrate, D=d₂, d₂>>d₁. FIG. 2 depicts a searching for decodable indicia performed on a frame 6004 captured by an indicia reading terminal at a longer terminal to target distance, in accordance with terminal 1000, D=d₂, d₂>>d₁. At the longer terminal to target distance, a searching for decodable indicia can be along search pattern 6014. In accordance with search pattern 6014, searching does not commence at a center 6050 of frame; but rather at a search commencement pixel position 6013 offset from a center pixel position 6050 of a frame.

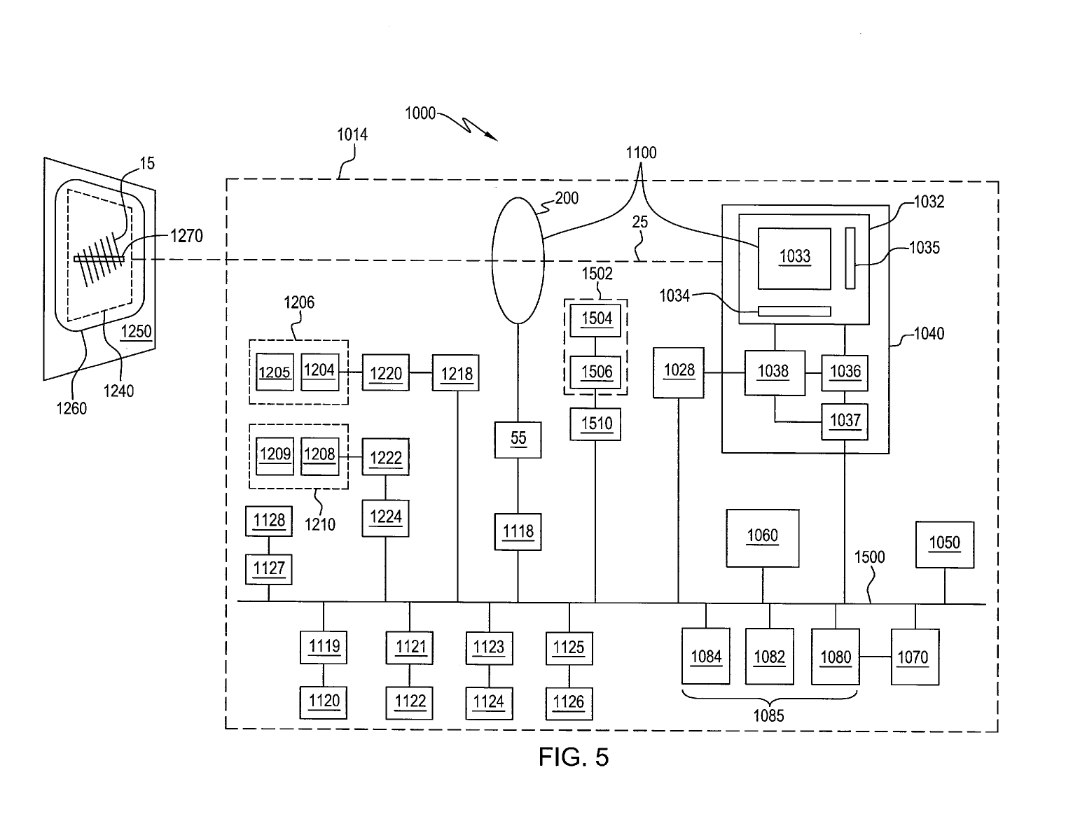

In the development of apparatuses and methods set forth herein it was determined that a projected light pattern of terminal 1000 such as aiming pattern 1270 projected by an indicia reading terminal as will be set forth further herein because of manufacturing tolerances, can be increasingly offset from a true center of a field of view of an indicia reading terminal at longer reading distances. FIGS. 3 and 4 are representations of aiming patterns 1270 projected on a target substrate at a first shorter reading distance (FIG. 3) and a second longer reading distance (FIG. 4). In FIG. 3, aiming pattern 1270 can be projected at a center 7050 of a field of view 1240 of a terminal 1000. However, at a longer reading distance, because of manufacturing tolerances, aiming pattern 1270 can be projected at a position offset from a center 7050 of a field of view 1240. Because of the position of an aiming pattern due to manufacturing tolerances “floating” to an increasingly offset position at longer distances, it was determined in the development of apparatus and methods herein that at longer distances, a user of an indicia reading terminal who aims pattern 1270 at a target indicia can in fact be aiming a terminal where a decodable indicia 15 (FIG. 5), in a field of view 1240, is offset from center 7050 of a field of view 1240. Illumination pattern 1260, described in connection with FIG. 5, is not depicted in the long range view of FIG. 4 since at longer ranges, light projected in the formation of illumination pattern 1260 can be diffused. Light that forms aiming pattern 1270 can, in one embodiment, be provided by collimated laser light which is not diffused and instead is easily viewed at longer range. At longer range, in one embodiment, aiming pattern 1270 can be expected to consume a smaller portion of a terminal field of view 1240, as is depicted in FIG. 4.

In accordance with apparatus and methods herein, a manner in which a decodable indicia is searched for, e.g. as determined by a search commencement pixel position, can be responsive to a terminal to target distance. In such manner, a speed with which a decodable indicia representation can be located can be increased.

In one embodiment, there is set forth herein an indicia reading terminal having light pattern projection assembly for projection of a light pattern; an imaging assembly including an image sensor array and an imaging lens assembly for focusing an image of a target onto the image sensor array; and a hand held housing incorporating the image sensor array. In one embodiment, the light pattern can be provided by an aiming pattern 1270. The indicia reading terminal can be operative so that when a trigger signal is activated, the indicia reading terminal captures one or more frames, and the light pattern projection assembly can be controlled so that a light pattern is projected during an exposure period of at least one of the one or more frames. The indicia reading terminal can be further operative so that when the trigger signal is activated, the indicia reading terminal processes at least one of the one or more frames for determination of one or more of a location and size of a representation of the aiming pattern. Further, the indicia reading terminal can be operative so that when the trigger signal is activated, the indicia reading terminal establishes a manner in which a decodable indicia representation is searched for in at least one of the one or more frames utilizing one or more of a location and size of the representation of the light pattern. In one embodiment, an indicia reading terminal can be operative so that a manner in which a decodable indicia representation is searched for is responsive to a terminal to target distance.

An exemplary hardware platform for support of operations described herein with reference to an image sensor based indicia reading terminal is shown and described with reference to FIG. 5.

Indicia reading terminal 1000 can include an image sensor 1032 comprising a multiple pixel image sensor array 1033 having pixels arranged in rows and columns of pixels, associated column circuitry 1034 and row circuitry 1035. Associated with the image sensor 1032, can be amplifier circuitry 1036 and an analog to digital converter 1037. Analog to digital converter 1037 converts image information in the form of analog signals read out of image sensor array 1033 into image information in the form of digital signals. Image sensor 1032 can also have an associated timing and control circuit 1038 for use in controlling, for e.g., the exposure period of image sensor 1032, gain applied to the amplifier 1036. The noted circuit components 1032, 1036, 1037, and 1038 can be packaged into a common image sensor integrated circuit 1040. In one example, image sensor integrated circuit 1040 can be provided by an MT9V022 image sensor integrated circuit available from Micron Technology, Inc. In another example, image sensor integrated circuit 1040 can incorporate a Bayer pattern filter. In such an embodiment, CPU 1060 prior to subjecting a frame to further processing can interpolate pixel values intermediate of green pixel values for development of a monochrome frame of image data.

In the course of operation of terminal 1000, image signals can be read out of image sensor 1032, converted and stored into a system memory such as RAM 1080. A memory 1085 of terminal 1000 can include RAM 1080, a nonvolatile memory such as EPROM 1082 and a storage memory device 1084 such as may be provided by a flash memory or a hard drive memory. In one embodiment, terminal 1000 can include CPU 1060 which can be adapted to read out image data stored in memory 1080 and subject such image data to various image processing algorithms. Terminal 1000 can include a direct memory access (DMA) unit 1070 for routing image information read out from image sensor 1032 that has been subject to conversion to RAM 1080. In another embodiment, terminal 1000 can employ a system bus providing for bus arbitration mechanism (e.g., a PCI bus) thus eliminating the need for a central DMA controller. A skilled artisan would appreciate that other embodiments of the system bus architecture and/or direct memory access components providing for efficient data transfer between the image sensor 1032 and RAM 1080 are within the scope and the spirit of the invention.

Referring to further aspects of terminal 1000, lens assembly 200 can be adapted for focusing an image of a decodable indicia 15 located within a field of view 1240 on a substrate 1250 onto image sensor array 1033. Imaging light rays can be transmitted about imaging axis 25. Lens assembly 200 can be adapted to be capable of multiple focal lengths and multiple best focus distances. A combination of image sensor array 1033 and imaging lens assembly 200 can be regarded as an imaging assembly 1100.

Terminal 1000 can also include an illumination pattern light source bank 1204 and associated light shaping optics 1205 for generating an illumination pattern 1260 substantially corresponding to a field of view 1240 of terminal 1000. The combination of bank 1204 and optics 1205 can be regarded as an illumination light pattern projection assembly 1206. Terminal 1000 can also include an aiming pattern light source bank 1208 and associated light shaping optics 1209 for generating an aiming pattern 1270 on substrate 1250. The combination of bank 1208 and optics 1209 can be regarded as an aiming pattern light projection assembly 1210. In use, terminal 1000 can be oriented by an operator with respect to a substrate 1250 bearing decodable indicia 15 in such manner that aiming pattern 1270 is projected on a decodable indicia 15. In the example of FIG. 5, decodable indicia 15 is provided by a 1D bar code symbol. Decodable indicia 15 could also be provided by a 2D bar code symbol or optical character recognition (OCR) characters. Each of illumination pattern light source bank 1204 and aiming pattern light source bank 1208 can include one or more light sources.

Lens assembly 200 can be controlled with use of electrical power input unit 55 which provides energy for changing a plane of optimal focus of lens assembly 200. In one embodiment, an electrical power input unit 55 can operate as a controlled voltage source, and in another embodiment, as a controlled current source. Illumination pattern light source bank 1204 can be controlled with use of illumination pattern light source control circuit 1220. Aiming pattern light source bank 1208 can be controlled with use of aiming pattern light source bank control circuit 1222.

Electrical power input unit 55 can apply signals for changing optical characteristics of lens assembly 200, e.g., for changing a focal length and/or a best focus distance of (a plane of optimum focus of) lens assembly 200. Illumination pattern light source bank control circuit 1220 can send signals to illumination pattern light source bank 1204, e.g., for changing a level of illumination output by illumination pattern light source bank 1204. Aiming pattern light source bank control circuit 1222 can send signals to aiming pattern light source bank 1208, e.g., for changing a level of illumination output by aiming pattern light source bank 1208.

Terminal 1000 can also include a number of peripheral devices including trigger 1120 which may be used to make active a trigger signal for activating frame readout and/or certain decoding processes. Terminal 1000 can be adapted so that activation of trigger 1120 activates a trigger signal and initiates a decode attempt. Specifically, terminal 1000 can be operative so that in response to activation of a trigger signal, a succession of frames can be read out and captured by way of read out of image information from image sensor array 1033 (typically in the form of analog signals) and then storage of the image information after conversion into memory 1080 (which can buffer one or more of the succession of frames at a given time).

CPU 1060 can be operative to subject one or more of the succession of frames to a decode attempt. For attempting to decode a bar code symbol, CPU 1060 can process image data of a frame corresponding to a line of pixel positions (e.g., a row, a column, or a diagonal set of pixel positions) to determine a spatial pattern of dark and light cells and can convert each light and dark cell pattern determined into a character or character string via table lookup.

Terminal 1000 can include various interface circuits for coupling various of the peripheral devices to system address/data bus (system bus) 1500, for communication with CPU 1060 also coupled to system bus 1500. Terminal 1000 can include interface circuit 1028 for coupling image sensor timing and control circuit 1038 to system bus 1500, interface circuit 1118 for coupling electrical power input unit 55 to system bus 1500, interface circuit 1218 for coupling illumination light source bank control circuit 1220 to system bus 1500, interface circuit 1224 for coupling aiming light source bank control circuit 1222 to system bus 1500, and interface circuit 1119 for coupling trigger 1120 to system bus 1500. Terminal 1000 can also include a display 1122 coupled to system bus 1500 and in communication with CPU 1060, via interface 1121, as well as pointer mechanism 1124 in communication with CPU 1060 via interface 1123 connected to system bus 1500. Terminal 1000 can also include keyboard 1126 in communication with CPU 1060 via interface 1125 connected to system bus 1500. Terminal 1000 can also include range detector 1128 in communication with CPU 1060 via interface 1127 connected to system bus 1500. Range detector 1128 can be e.g., an ultrasonic range detector.

A succession of frames of image data that can be captured and subject to the described processing can be full frames (including pixel values corresponding to more than about 80% of pixels of image sensor 1032). A succession of frames of image data that can be captured and subject to the described processing (e.g., frame quality evaluation processing) can also be “windowed frames” comprising pixel values corresponding to less than about 80%, and in some cases less than about 50% and in some cases less than 10% of pixels of image sensor 1032. A succession of frames of image data that can be captured and subject to the described processing can also comprise a combination of full frames and windowed frames. A full frame can be captured by selectively addressing for readout pixels of image sensor 1032 corresponding to the full frame. A windowed frame can be captured by selectively addressing for readout pixels of image sensor 1032 corresponding to the windowed frame.

Terminal 1000 can capture frames of image data at a rate known as a frame rate. A typical frame rate is 60 frames per second (FPS) which translates to a frame time (frame period) of 16.6 ms. Another typical frame rate is 30 frames per second (FPS) which translates to a frame time (frame period) of 33.3 ms per frame.

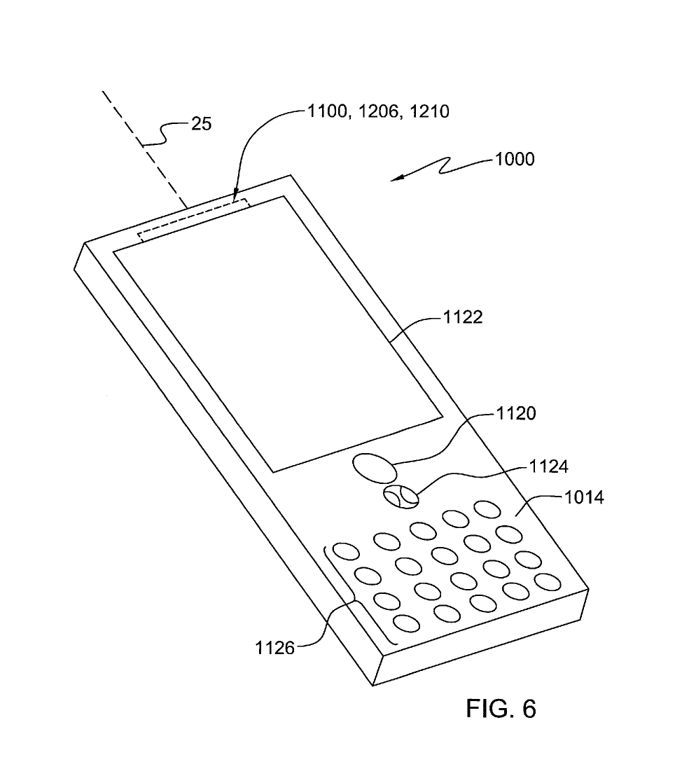

A physical form view of terminal 1000 in one embodiment is shown in FIG. 6. Trigger 1120, display 1122, pointer mechanism 1124, and keyboard 1126 can be disposed on a common side of a hand held housing 1014 as shown in FIG. 6. Display 1122 and trigger 1120 and pointer mechanism 1124 in combination can be regarded as a user interface of terminal 1000. Display 1122 in one embodiment can incorporate a touch panel for navigation and virtual actuator selection a virtual trigger display in which case a user interface of terminal 1000 can be provided by display 1122. A user interface of terminal 1000 can also be provided by configuring terminal 1000 to be operative to be reprogrammed by decoding of programming bar code symbols. A hand held housing 1014 for terminal 1000 can in another embodiment be devoid of a display and can be in a gun style form factor. Imaging assembly 1100, light pattern projection assembly 1206 and light pattern projection assembly 1210 can be disposed in hand held housing 1014.

There is set forth herein an indicia reading terminal in which a manner in which a decodable indicia is searched for can be responsive to a terminal to target distance. For example referring to FIG. 1, FIG. 1 is a representation of a frame of image data captured with a terminal 1000 being at a first close range distance to a target substrate, D=d₁. When frame 6002 captured at close range is subject to decoding, a search pattern 6012 can be utilized in accordance with search pattern 6012 having a search pattern commencement position 6011 coincident with a center 6050 of a frame 6002. However at long range, with use of terminal 1000 a manner of searching for decodable indicia can be different. FIG. 2 depicts a searching for decodable indicia performed on a frame 6004 captured by an indicia reading terminal 1000 at a longer terminal to target distance. At the longer terminal to target distance a searching for decodable indicia can be along pattern 6014 having a search pattern commencement position 6013 offset from a center 6050 of a frame 6004. In accordance with pattern 6014 searching does not commence at a center of a frame; but rather at a position 6013 offset from a center pixel position 6050.

In the development of terminal 1000, it was determined that because of manufacturing tolerances, at longer reading distances, an aiming pattern 1270 projected by an indicia reading terminal 1000 can be increasingly offset from a true center 7050 of a field of view of an indicia reading terminal. FIGS. 3 and 4 are representations of aiming patterns 1270 projected on a target substrate at a first shorter reading distance (FIG. 3) and a second longer reading distance (FIG. 4). In FIG. 3 aiming pattern 1270 is projected at a center 7050 of a field of view 1240. However, at a longer reading distance, because of manufacturing tolerances (FIG. 4), aiming pattern 1270 can be projected at a position offset from a center 7050 of a field of view 1240. Because of the position of an aiming pattern 1270 “floating” to an increasing offset position at longer distances due to manufacturing tolerances, it was determined that in the development of terminal 1000, at longer distances, a user of a terminal 1000 who aims pattern 1270 at a target indicia can in fact be aiming a terminal in such manner that a decodable indicia 15 (FIG. 5) in a field of view 1240 is offset from center 7050 of a field of view.

In accordance with terminal 1000, a manner in which a decodable indicia is searched or, e.g., a search commencing pixel position controlling a start position for a search can be responsive to a terminal to target distance. In such manner a speed with which a decodable indicia representation can be listed in a frame can be increased.

In the development of terminal 1000, it was determined that a manner in which a position of aiming pattern 1270 “floats” with increasing terminal distance is likely to vary from terminal to terminal. That is, manufacturing tolerances are not likely to be consistent between terminals; they are likely to be different for different terminals. In one embodiment, terminal 1000 can be subject to a calibration process for determining a pixel position of a representation of pattern 1270 in a captured frame at various terminal distances. In the case that aiming pattern 1270 is projected using collimated light, a pixel position of a representation of aiming pattern 1270 for any terminal distance can be calculated by measuring empirically the position at two or more terminal to target distance. Accordingly, a calibration process can be as follows: (a) position the terminal at a first distance; record pixel position at which aiming pattern 1270 is represented and a size of a representation of aiming pattern 1270; (b) position the terminal at a second distance from a target; record pixel position at which the aiming pattern 1270 is represented and a size of a representation of aiming pattern 1270; and (c) interpolate aiming pattern representation pixel positions and aiming pattern representation sizes for additional terminal to target distances utilizing the data recorded during performance of (a) and (b). In the aforementioned example, a position of an aiming pattern representation can be regarded to be a center of an aiming pattern representation throughout all terminal to target distances in the providing of a lookup table.

A location at which to commence a search at any terminal distance can be established to coincide with an expected pixel position of a representation of aiming pattern 1270 at any terminal to target distance. A lookup table 8002 as shown in FIG. 6 correlating aiming pattern representation pixel position and size with terminal target distance can be established and can be utilized for controlling decoding operations; namely, for example, by controlling a search commencement pixel position. Lookup table 8002 can be stored in memory 1085. During calibration, terminal 1000 can be operated so that in the exposure of test frames used for calibrating, aiming pattern 1270 can be controlled to be “on” during exposure periods for the various captured test frames.

In one embodiment, terminal 1000 can determine a manner in which to search for decodable indicia utilizing a determined terminal to target distance. In such an embodiment, terminal 1000 can include a lookup table 8002 correlating terminal distances to pixel positions corresponding to representation of aiming pattern 1270. While lookup table 8002 in the example provided includes rows and columns of values, lookup table 8002 can also be provided by a mathematical equation. Terminal 1000 can determine a manner of performing a search for a decodable indicia representation by determining a search start pixel position responsively to a determined distance. A terminal to target distance (range) can be determined utilizing any available ranging method. In one example, terminal 1000 includes a range detector 1128 for detecting a current range of a terminal 1000 from a target substrate (target) 1250 (FIG. 5). Range detector 1128 in one example can be ultrasonic based.

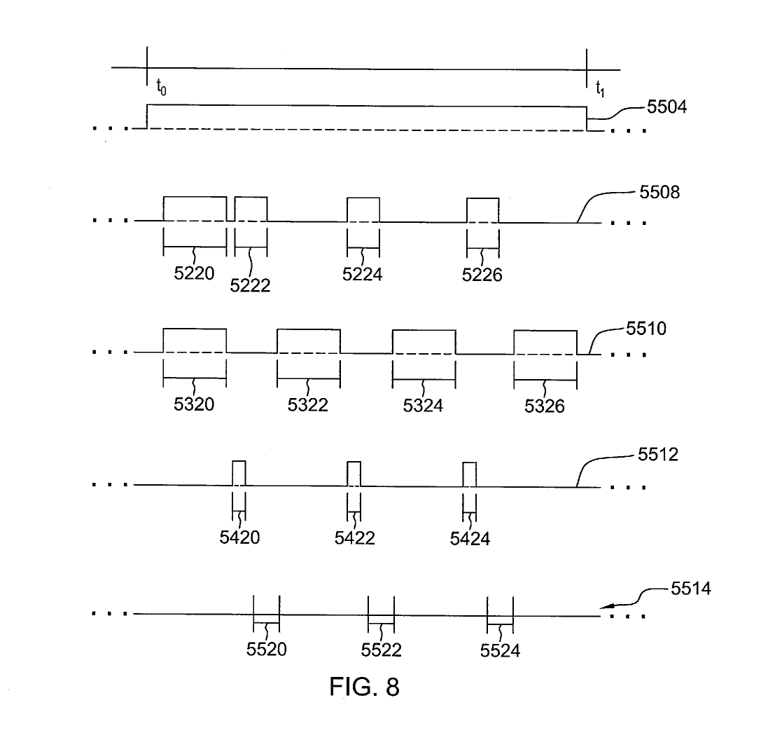

In one embodiment, a range of terminal 1000 can be determined using aiming pattern 1270. If aiming pattern 1270 is projected using collimated light, a distance of terminal 1000 can be determined with use of lookup table 8002 by determining the position of a representation of aiming pattern 1270 in a captured frame or a size of a representation of aiming pattern 1270 in a captured frame. An embodiment wherein a terminal target distance is determined using a captured frame having a representation of aiming pattern 1270 is set forth with reference to the timing diagram of FIG. 8.

Referring to the timing diagram of FIG. 8, signal 5504 is a trigger signal which can be made active by actuation of trigger 1120, and which can be deactivated by releasing of trigger 1120. A trigger signal may also become inactive after a time out period or after a successful decode of a decodable indicia. Signal 5510 is an exposure signal. Logic high periods of signal 5510 define exposure periods 5320, 5322, 5324, and 5326. Signal 5512 is a read out signal. Logic high periods of signal 5512 define read out periods 5420, 5422, and 5424. Processing periods 5520, 5522, and 5524 can represent processing periods during which time CPU 1060 of terminal 1000 processes stored (e.g., buffered) frames representing a substrate that can bear decodable indicia. Such processing can include processing for attempting to decode a decodable indicia as described herein.

With further reference to the timing diagram of FIG. 8, an operator at time, tₒ, can activate trigger signal 5504 (e.g., by depression of trigger 1120). In response to trigger signal 5504 being activated, terminal 1000 can expose a succession of frames. During each exposure period 5320, 5322, 5324, 5326 a frame of image data can be exposed.

Referring further to the timing diagram of FIG. 8, signal 5508 is a light pattern control signal. Logic high periods of signal 5508, namely periods 5220, 5222, 5224, 5226 define “on” periods for projected aiming pattern 1270. The aiming pattern light projection assembly 1210 can be energized to project aiming pattern 1270 during period 5220 coinciding with exposure period 5320 so that a representation of aiming pattern 1270 is included in a captured frame of image data having corresponding exposure period 5320. Thereafter, the aiming pattern “on” periods 5222, 5224 and 5226 do not coincide with any of the subsequent exposure periods, for example, exposure periods 5322, 5324 and 5326. At time t₁, trigger signal can be deactivated e.g., by successful decode, a timeout condition being satisfied, or a release of trigger 1120.

In one embodiment, there are a succession of frames exposed, read out and subject to processing during a time that trigger signal 5504 is active. The processing of each frame can include a decode attempt as described herein. As explained, a trigger signal 5504 can be made active by depression of trigger 1220 and can be de-activated by release of trigger 1120 or a successful decode or expiration of a timeout.

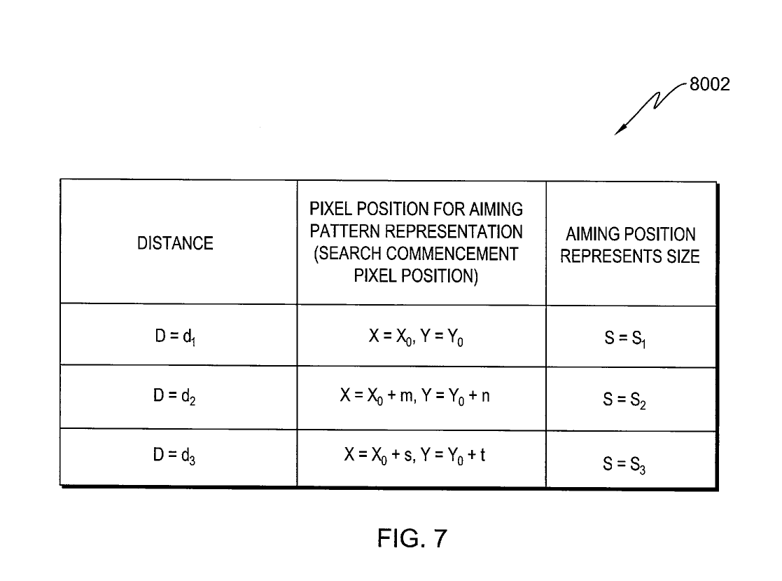

In one embodiment, terminal 1000 can determine a terminal to target distance e.g., using range detector 1128 or a representation of a light pattern e.g., aiming pattern 1270 (e.g., by determining one or more of a position and size of a representation of aiming pattern 1270) and then can utilize lookup table 8002 (FIG. 7) to determine an expected pixel position center of aiming pattern representation and search commencement pixel position.

In another embodiment, terminal 1000 can establish a search commencement pixel position as the position of a center of a representation of an aiming pattern 1270 without reading an expected aiming pattern representation center position and search commencement position from lookup table 8002 and in one embodiment without determining a terminal to target distance. More specifically, terminal 1000 can be operative so that a search commencement pixel position is determined responsively to a determined position of a representation of aiming pattern 1270 without lookup of a terminal to target distance or any other data from lookup table 8002. In such embodiment, terminal 1000 can be devoid of lookup table 8002. In such embodiment, a search commencement pixel position can be expected to coincide with a position of a representation of aiming pattern 1270 even in the case that an aiming light pattern projection assembly 1210 becomes misaligned over time such that an offset profile of aiming pattern 1270 (the manner in which a position of an aiming pattern 1270 in a field of view varies over changing distances) differs from an offset profile of aiming pattern 1270 at an earlier point in time.

A small sample of systems, methods and apparatus that are described herein is as follows:

A1. An indicia reading terminal comprising: a light pattern projection assembly for projection of a light pattern; an imaging assembly including an image sensor array and an imaging lens assembly for focusing an image of a target onto the image sensor array; a housing having disposed therein the image sensor array; wherein the indicia reading terminal is operative so that responsively to a trigger signal being activated, the indicia reading terminal captures one or more frames, wherein the indicia reading terminal is further operative to attempt to decode a decodable indicia utilizing one or more of the one or more frames, and wherein the indicia reading terminal is operative to determine a manner in which a decodable indicia representation is searched for in the one or more of the one or more frames utilizing a determined terminal to target distance of the indicia reading terminal.

A2. The indicia reading terminal of A1, wherein the indicia reading terminal is operative to determine the terminal to target distance using a range detector.

A3. The indicia reading terminal of A1, wherein the indicia reading terminal is operative to determine the terminal to target distance using a representation of the light pattern represented in a frame of image data captured using the imaging subsystem.

A4. The indicia reading terminal of A1, wherein the indicia reading terminal is operative to determine search commencement position for searching for a decodable indicia representation in the one or more of the one or more frames utilizing a determined terminal to target distance of the indicia reading terminal.

A5. The indicia reading terminal of A1, wherein the housing is a hand held housing.

A6. The indicia reading terminal of A1, wherein the light pattern is an aiming pattern.

A7. The indicia reading terminal of A1, wherein the indicia reading terminal to determine the manner in which a decodable indicia is searched for utilizes a lookup table established during a calibration process in which data of one or more of a size and position of a representation of a light pattern is recorded at a plurality of terminal to target distance.

A8. The indicia reading terminal of A1, wherein the indicia reading terminal to determine the manner in which the decodable indicia is searched for utilizes a lookup table that correlates one or more of light pattern size and position to terminal to target distance.

B1. An indicia reading terminal comprising: a light pattern projection assembly for projection of a light pattern; an imaging assembly including an image sensor array and an imaging lens assembly for focusing an image of a target onto the image sensor array; a housing having disposed therein the image sensor array; wherein the indicia reading terminal is operative so that responsively to a trigger signal being activated, the indicia reading terminal captures one or more frames, wherein the light pattern projection assembly is controlled so that the light pattern is projected during an exposure period of at least one of the one or more frames, wherein the indicia reading terminal is further operative so that responsively to the trigger signal being activated, the indicia reading terminal processes at least one of the one or more frames for determining one or more of a location and size of a representation of the light pattern, and wherein the indicia reading terminal is further operative so that responsively to the trigger signal being activated, the indicia reading terminal establishes a manner in which a decodable indicia representation is searched for in at least one of the one or more frames utilizing one or more of a location and size of the representation of the light pattern.

B2. The indicia reading terminal of B1, wherein the one or more of a location and size of the light pattern representation is located using a first frame of the one or more frames, and the decodable indicia is searched using second frame of the one or more frames, the second frame being subsequent to the first frame.

B3. The indicia reading terminal of B2, wherein the indicia reading terminal is operative so that the first frame and the second frame are non-successive frames captured during a single trigger signal activation period.

B4. The terminal of B1, wherein the housing is a hand held housing.

B5. The indicia reading terminal of B1, wherein the indicia reading terminal is operative to determine search commencement position for searching for a decodable indicia representation in the one or more of the one or more frames utilizing the one or more of a location and size of the light pattern representation.

B6. The indicia reading terminal of B1, wherein the indicia reading terminal utilizes the one or more of a location and size of the light pattern representation to determine a terminal to target distance and then reads a search commencement position from a lookup table correlating search commencement positions with terminal to target distances.

B7. The indicia reading terminal of B1, wherein the indicia reading terminal utilizes a location light pattern representation to establish a search commencement position by establishing location of the light pattern representation as the search commencement position.

B8. The indicia reading terminal of B1, wherein the light pattern is an aiming pattern.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than or greater than the mentioned certain number of elements. Also, while a number of particular embodiments have been described, it will be understood that features and aspects that have been described with reference to each particular embodiment can be used with each remaining particularly described embodiment.

1. An indicia reading terminal comprising: a light pattern projection assembly for projection of a light pattern; an imaging assembly including an image sensor array and an imaging lens assembly for focusing an image of a target onto the image sensor array; a housing having disposed therein the image sensor array; wherein the indicia reading terminal is operative so that responsively to a trigger signal being activated, the indicia reading terminal captures one or more frames, wherein the indicia reading terminal is further operative to attempt to decode a decodable indicia utilizing one or more of the one or more frames, and wherein the indicia reading terminal is operative to determine a manner in which a decodable indicia representation is searched for in the one or more of the one or more frames utilizing a determined terminal to target distance of the indicia reading terminal.

2. The indicia reading terminal of claim 1, wherein the indicia reading terminal is operative to determine the terminal to target distance using a range detector.

3. The indicia reading terminal of claim 1, wherein the indicia reading terminal is operative to determine the terminal to target distance using a representation of the light pattern represented in a frame of image data captured using the imaging subsystem.

4. The indicia reading terminal of claim 1, wherein the indicia reading terminal is operative to determine search commencement position for searching for a decodable indicia representation in the one or more of the one or more frames utilizing a determined terminal to target distance of the indicia reading terminal.

5. The indicia reading terminal of claim 1, wherein the housing is a hand held housing.

6. The indicia reading terminal of claim 1, wherein the light pattern is an aiming pattern.

7. The indicia reading terminal of claim 1, wherein the indicia reading terminal to determine the manner in which a decodable indicia is searched for utilizes a lookup table established during a calibration process in which data of one or more of a size and position of a representation of a light pattern is recorded at a plurality of terminal to target distance.

8. The indicia reading terminal of claim 1, wherein the indicia reading terminal to determine the manner in which the decodable indicia is searched for utilizes a lookup table that correlates one or more of light pattern size and position to terminal to target distance.

9. An indicia reading terminal comprising: a light pattern projection assembly for projection of a light pattern; an imaging assembly including an image sensor array and an imaging lens assembly for focusing an image of a target onto the image sensor array; a housing having disposed therein the image sensor array; wherein the indicia reading terminal is operative so that responsively to a trigger signal being activated, the indicia reading terminal captures one or more frames, wherein the light pattern projection assembly is controlled so that the light pattern is projected during an exposure period of at least one of the one or more frames, wherein the indicia reading terminal is further operative so that responsively to the trigger signal being activated, the indicia reading terminal processes at least one of the one or more frames for determining one or more of a location and size of a representation of the light pattern, and wherein the indicia reading terminal is further operative so that responsively to the trigger signal being activated, the indicia reading terminal establishes a manner in which a decodable indicia representation is searched for in at least one of the one or more frames utilizing one or more of a location and size of the representation of the light pattern.

10. The indicia reading terminal of claim 9, wherein the one or more of a location and size of the light pattern representation is located using a first frame of the one or more frames, and the decodable indicia is searched using second frame of the one or more frames, the second frame being subsequent to the first frame.

11. The indicia reading terminal of claim 10, wherein the indicia reading terminal is operative so that the first frame and the second frame are non-successive frames captured during a single trigger signal activation period.

12. The terminal of claim 9, wherein the housing is a hand held housing.

13. The indicia reading terminal of claim 9, wherein the indicia reading terminal is operative to determine search commencement position for searching for a decodable indicia representation in the one or more of the one or more frames utilizing the one or more of a location and size of the light pattern representation.

14. The indicia reading terminal of claim 9, wherein the indicia reading terminal utilizes the one or more of a location and size of the light pattern representation to determine a terminal to target distance and then reads a search commencement position from a lookup table correlating search commencement positions with terminal to target distances.

15. The indicia reading terminal of claim 9, wherein the indicia reading terminal utilizes a location light pattern representation to establish a search commencement position by establishing location of the light pattern representation as the search commencement position.

16. The indicia reading terminal of claim 9, wherein the light pattern is an aiming pattern.
